(19) United States
(12) Patent Application Publication
(10) Pub. No.: US 2020/0307319 A1
(43) Pub. Date: Oct. 1, 2020

(54) LOW NOISE TIRE TREAD

(71) Applicant: The Goodyear Tire & Rubber Company, Akron, OH (US)

(72) Inventors: Gilles Reichling, Vichten (LU); Erik de Wit, Diekirch (LU); Melodie Dubreuil, Diekirch (LU); Julien Alexandre Vaissaud, Arlon (BE); Richard Mbewo Samwayera Fosam, Moesdorf (LU); Robin Moia, Metz (FR); Olivier Guy Jacques, Mertzig (LU); Pascal Pletschette, Mullendorf (LU); Doris Maus, Wasserliesch (DE)

(21) Appl. No.: 16/368,949

(22) Filed: Mar. 29, 2019

(51) Int. Cl. B60C 11/03; B60C 11/12

(52) U.S. Cl. CPC B60C 11/0304; B60C 11/0302; B60C 2011/1209; B60C 11/1236; B60C 11/1259; B60C 11/1204

(57) ABSTRACT

A tread has a midcircumferential plane, a first axial tread edge, and a second axial tread edge. The tread includes a first shoulder rib extending circumferentially about a perimeter of the tread, a second shoulder rib extending circumferentially about the perimeter of the tread, and a first intermediate rib extending circumferentially about the perimeter of the tread. The first intermediate rib is defined by a first and a second circumferentially extending groove disposed to each axial side of the first intermediate rib. The first intermediate rib has a first plurality of angled sipes extending both axially and circumferentially at an angle between 50° and 70° relative to the first circumferentially extending groove. The angled sipes each have a radial depth of between 1.0 mm and 3.0 mm.

### FIELD OF THE INVENTION

This invention relates generally to a tire and, more particularly, to a tread for a tire having a low noise tread configuration.

### BACKGROUND OF THE INVENTION

It is known that in pneumatic tires the radially outer surface, axially extending from one tire sidewall to the other, may be provided with a plurality of grooves in the thickness of the tread band and arranged in various ways in order to divide the band into ridges and/or blocks, mutually spaced from one another by such grooves. The ridges and blocks may be provided with “lamels”, namely thin slits directed from the outer surface towards the inside of the tire. These slits may be of variable depth and reach the sides of the ridges and/or blocks.

The structure formed by the grooves and the slits may constitute a “tread pattern”, which is a typical and characterizing component of the tire, variable in accordance with a determined use for the tire. By way of example, specialized tires of a “winter” type may have a tread pattern with a large number of blocks and deep grooves in order to increase road holding on snowy and/or muddy ground peculiar to the winter season. Tread patterns of tires to be used on well maintained roads in normal weather under normal service conditions may be characterized by large circumferential ridges having a zig-zag path, from which transverse grooves may depart. The grooves of the normal pattern may be thinner than the winter pattern. Such normal or “summer patterns” may penetrate a liquid layer between the tire and a wet road surface (for instance when it rains) thereby ensuring good maneuverability, satisfactory driving stability, and good grip on a wet road surface. Such summer patterns may further possess uniform wear, silent running, and comfort characteristics.

Uniform wear of a tread pattern may result from a large ratio between solid and hollow areas, called “filling coefficient” or “net to gross ratio”. Thus, a compact tread, having few movable blocks below the impression area and few thin grooves, may negatively effect the tire behavior in respect of the wet grip or aquaplaning phenomenon. To avoid aquaplaning, a “wet pattern” may have widely spaced blocks provided with several slits, or many large grooves and a low filling coefficient. These features, which increase the mobility of the blocks below the impression area, may negatively effect the achievement of a uniform and slowly wearing tire. Further, wet patterns of this kind may be audibly noisy, even on smooth roads in good conditions, because these patterns generate a series of acoustic phenomena, that is, main waves and their harmonics, of a particular frequency which often resonate with each other, and are very difficult to eliminate or attenuate.

What may generally be desired for good performance from a tire, whether operating in straightaway driving, cornering, accelerating or braking condition, may be a strong directional stability or handling, low rolling resistance, excellent riding comfort, relatively low audible noise emission, relatively high mileage tread life or wear, and relatively good traction. Also, the mass of the tire may be as low as possible for the loading range specified without decreasing the endurance or durability of the tire.

### Definitions

As used herein and in the claims:

“Apex” means an elastomeric filler located radially above the bead core and between the plies and the turnup ply.

“Annular” means formed like a ring.

“Aspect ratio” means the ratio of a tire section height to its section width.

“Aspect ratio of a bead cross-section” means the ratio of a bead section height to its section width.

“Asymmetric tread” means a tread that has a tread pattern not symmetrical about the centerplane or equatorial plane (EP) of the tire.

“Axial” and “axially” refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane (EP) of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane (EP) of the tire. If multiple plies are present, the ply cords run at opposite angles in alternating layers.

“Breakers” means at least two annular layers or plies of parallel reinforcement cords having the same angle with reference to the equatorial plane (EP) of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls, and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane (EP). The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made, that forms the basic element of filaments; characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High tensile steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360° rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Net contact area” means the total area of ground contacting elements between defined boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane (EP) of the tire.

“Radial ply tire” means a belted or circumferentially-restricted pneumatic tire in which at least one ply has cords which extend from bead to bead and the ply is laid at cord angles between 65° and 90° with respect to the equatorial plane (EP) of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane (EP).

“Section width” means the maximum linear distance parallel to the axis of the tire and between the exterior of its sidewalls when and after it has been inflated at normal pressure for 24 hours, but unloaded, excluding elevations of the sidewalls due to labeling, decoration, or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” is stress expressed as force per unit linear density of the unstrained specimen (gm/tex or gm/denier).

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### SUMMARY OF THE INVENTION

A tread in accordance with the present invention has a midcircumferential plane, a first axial tread edge, and a second axial tread edge. The tread includes a first shoulder rib extending circumferentially about a perimeter of the tread, a second shoulder rib extending circumferentially about the perimeter of the tread, and a first intermediate rib extending circumferentially about the perimeter of the tread. The first intermediate rib is defined by a first and a second circumferentially extending groove disposed to each axial side of the first intermediate rib. The first intermediate rib has a first plurality of angled sipes extending both axially and circumferentially at an angle between 50° and 70° relative to the first circumferentially extending groove. The angled sipes each have a radial depth of between 1.0 mm and 3.0 mm.

According to another aspect of the tread, the angled sipes have a uniform radial depth between 1.5 mm and 2.5 mm.

According to still another aspect of the tread, the angled sipes extend at an angle of about 60° relative to the first circumferentially extending groove.

According to yet another aspect of the tread, the angled sipes have a uniform radial depth of about 2.0 mm.

According to still another aspect of the tread, a second intermediate rib extends circumferentially about the perimeter of the tread, the second intermediate rib being defined by the first circumferentially extending groove and a third circumferentially extending groove disposed to each axial side of the second intermediate rib, the second intermediate rib having a plurality of angled sipes extending both axially and circumferentially at an angle between 50° and 70° relative to the third circumferentially extending groove, the angled sipes each having a radial depth of between 1.0 mm and 3.0 mm.

According to yet another aspect of the tread, a third intermediate rib extends circumferentially about the perimeter of the tread, the third intermediate rib being defined by the third circumferentially extending groove and a fourth circumferentially extending groove disposed to each axial side of the third intermediate rib, the third intermediate rib having a plurality of angled sipes extending both axially and circumferentially at an angle between 50° and 70° relative to the fourth circumferentially extending groove, the angled sipes each having a radial depth of between 1.0 mm and 3.0 mm.

According to still another aspect of the tread, the second intermediate rib is axially disposed between the first intermediate rib and the third intermediate rib.

According to yet another aspect of the tread, the angled sipes of the first intermediate rib extend to a blind end at an axial location about midway across the first intermediate rib.

According to still another aspect of the tread, the angled sipes of the second intermediate rib extend to a blind end at an axial location about midway across the second intermediate rib.

According to yet another aspect of the tread, the angled sipes of the third intermediate rib extend to a blind end at an axial location about midway across the third intermediate rib.

A method according the present invention reduces pass-by-noise of a tread. The method includes the steps of: extending a first shoulder rib circumferentially about a perimeter of the tread; extending a second shoulder rib circumferentially about the perimeter of the tread; extending a first intermediate rib circumferentially about the perimeter of the tread; defining the first intermediate rib with a first and a second circumferentially extending groove disposed to each axial side of the first intermediate rib; extending a first plurality of angled sipes axially and circumferentially across the first intermediate rib at an angle between 50° and 70° relative to the second circumferentially extending groove; and extending the angled sipes to a radial depth of between 1.0 mm and 3.0 mm.

According to another aspect of the method, a further step includes extending the angled sipes to a uniform radial depth between 1.5 mm and 2.5 mm.

According to still another aspect of the method, a further step includes extending the angled sipes at an angle of about 60° relative to the first circumferentially extending groove.

According to yet another aspect of the method, a further step includes extending the angled sipes having a uniform radial depth of about 2.0 mm.

According to still another aspect of the method, further steps include extending a second intermediate rib circumferentially about the perimeter of the tread, defining the second intermediate rib by the first circumferentially extending groove and a third circumferentially extending groove disposed to each axial side of the second intermediate rib, extending a second plurality of angled sipes both axially and circumferentially across the second intermediate rib at an angle between 50° and 70° relative to the third circumferentially extending groove, and extending the second plurality of angled sipes each to a radial depth of between 1.0 mm and 3.0 mm.

According to yet another aspect of the method, further steps include extending a third intermediate rib circumferentially about the perimeter of the tread, defining the third intermediate rib the third circumferentially extending groove and a fourth circumferentially extending groove disposed to each axial side of the third intermediate rib, extending a third plurality of angled sipes both axially and circumferentially across the third intermediate rib at an angle between 50° and 70° relative to the fourth circumferentially extending groove, and extending the third plurality of angled sipes each to a radial depth of between 1.0 mm and 3.0 mm.

According to still another aspect of the method, a further step includes extending the second intermediate rib axially between the first intermediate rib and the third intermediate rib.

According to yet another aspect of the method, a further step includes extending the first plurality of angled sipes to a blind end at an axial location about midway across the first intermediate rib.

According to still another aspect of the method, a further step includes extending second plurality of angled sipes to a blind end at an axial location about midway across the second intermediate rib.

According to yet another aspect of the method, a further step includes extending the third plurality of angled sipes to a blind end at an axial location about midway across the third intermediate rib.

### BRIEF DESCRIPTION OF THE DRAWINGS

The features of the present invention will become apparent to those skilled in the art to which the present invention relates from reading the following specifications with reference to the accompanying drawings, in which:

FIG. 1 is a schematic perspective view of a tread of a tire in accordance with the present invention;

FIG. 2 is a schematic front elevation view of the tire of FIG. 1; and

FIG. 3 is a schematic sectional view taken along line ‘3-3’ in FIG. 2.

### DETAILED DESCRIPTION OF EXAMPLES OF THE PRESENT INVENTION

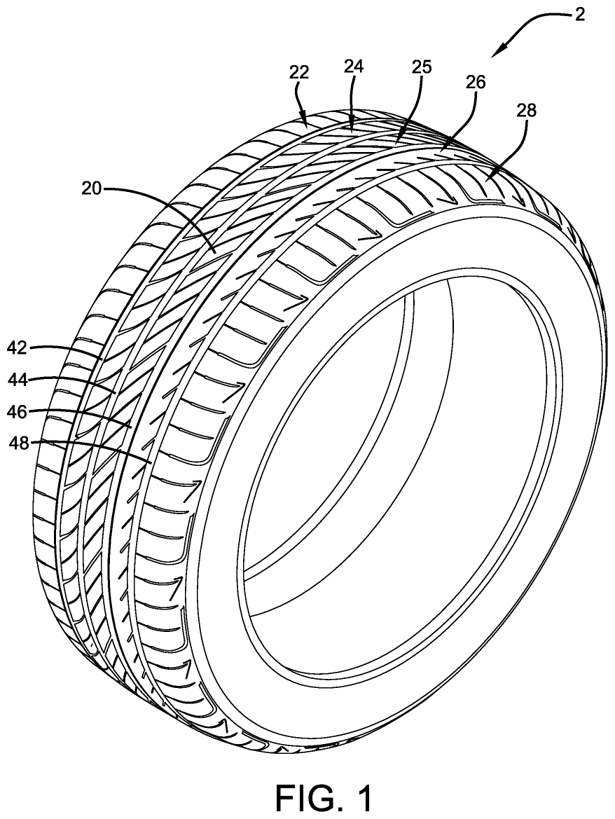

An example tire 2 in accordance with the present invention is illustrated in FIGS. 1-3. The tire 2 may be pneumatic or non-pneumatic. The tire 2 may be mounted on a vehicle wheel and connected to an axle of a vehicle, such as a passenger car, light truck, or the like. The tire 2 may be rotatable about a longitudinal rotation axis of the axle. A mid-circumferential plane M may extend perpendicular to the rotation axis and bisect the tire 2. The tire 2 may include a tread 20 and a radial carcass extending between a pair of inextensible beads, as shown in the example tire of U.S. Pat. No. 5,421,387, incorporated herein by reference in its entirety. Axially opposite ends of the carcass may be secured to a respective bead. The carcass may be flanked by two sidewalls. A belt package may be located between the carcass and the tread 20.

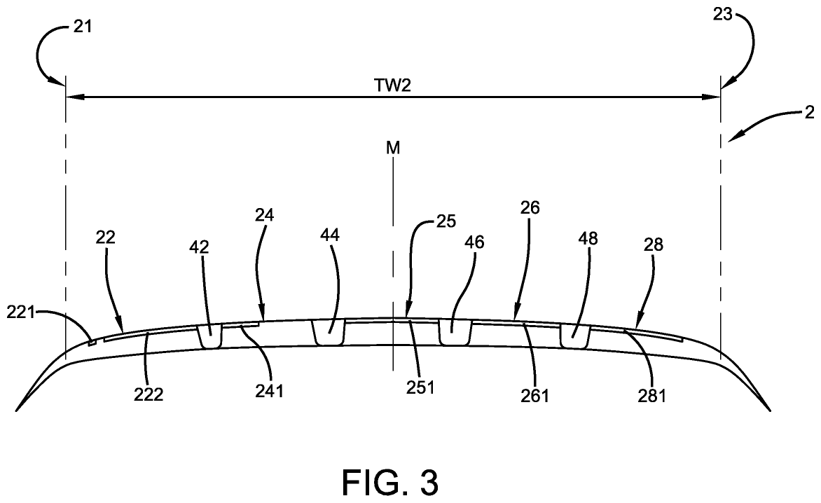

The tread 20 may have a tread width TW2 defined as above, or an axial distance widthwise across the tire 2 measured within the footprint of the tire when the tire 2 is contacting a road surface and when the tire 2 is inflated to a design pressure and loaded to a rated load. The tread width TW2 may be axially equidistant about the mid-circumferential plane M of the tire 2 (FIG. 3). The tread 20 may include five longitudinally extending ribs: a first rib 22, a second rib 24, a third rib 25, a fourth rib 26, and a fifth rib 28, spaced axially apart widthwise over the tread width TW2. The longitudinally extending ribs 22, 24, 25, 26, 28 may be separated by uninterrupted circumferential grooves 42, 44, 46, 48. Each circumferential groove 42, 44, 46, 48 has a respective width measured perpendicular to the mid-circumferential plane M. Each circumferential rib 22, 24, 25, 26, 28 may have a respective rib width measured perpendicular to the mid-circumferential plane M. The center rib 25 may be bisected by the mid-circumferential plane M.

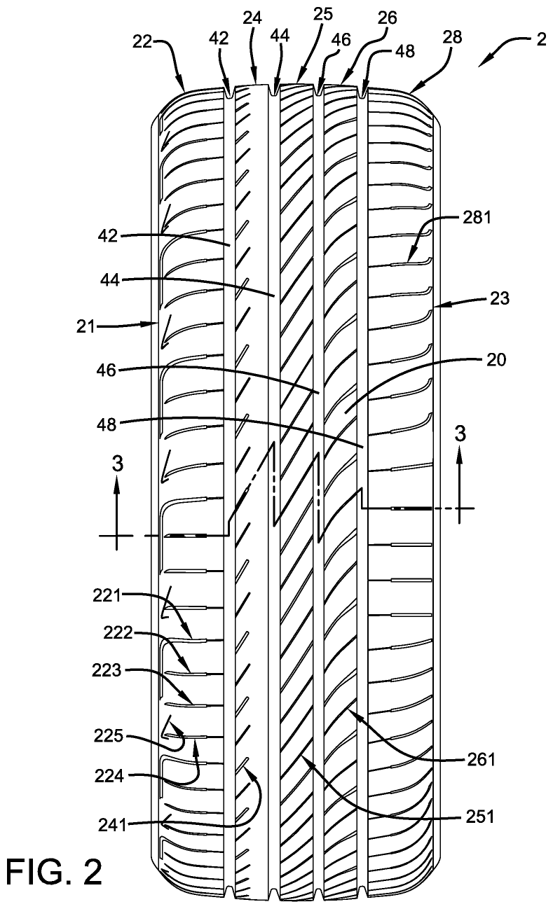

The first shoulder rib 22 may have first sipes 221, second sipes 222, third sipes 223, and fourth sipes 224. The first sipes 221 may extend axially outward from the axially outermost groove 42 toward a first tread edge 21. The first sipes 221 may simultaneously also curve in a circumferential direction adjacent the axially outer ends of the second and third sipes 222, 223 of the first shoulder rib 2 and parallel the first tread edge 21. The second sipes 222 may extend axially outward from the axially outermost groove 42 toward the first sipes 221 and the first tread edge 21. The third sipes 223 may extend axially outward from the axially outermost groove 42 toward the first sipes 221 and the first tread edge 21. The fourth sipes 224 may extend axially outward from the axially outermost groove 42 toward the first tread edge 21. Adjacent the axially outer edges of the fourth sipes 224 may be “check mark” shaped fifth sipes 225 (FIG. 2).

The second intermediate rib 24 may have angled sipes 241 extending axially inward from the axially outermost groove 42 to a blind end at an axial location about midway across the second rib 24. The angled sipes 241 may extend axially and circumferentially at an angle between 50° and 70°, or about 60° relative to the axially outermost groove 42. The angled sipes 241 may have a uniform radial depth between 1.0 mm and 3.0 mm, or 1.5 mm and 2.5 mm, or about 2.0 mm.

The third center rib 25 may be defined axially between the intermediate groove 44 and the intermediate groove 46. The third rib 25 may have angled sipes 251 extending axially from the intermediate groove 44 to the intermediate groove 46. The angled sipes 251 may extend axially and circumferentially at an angle between 50° and 70°, or about 60° relative to the intermediate grooves 44, 46. The angled sipes 251 may have a uniform radial depth between 1.0 mm and 3.0 mm, or 1.5 mm and 2.5 mm, or about 2.0 mm.

The fourth intermediate rib 26 may have angled sipes 261 extending axially inward from the axially outermost groove 48 to the intermediate groove 46 across the fourth rib 26. The angled sipes 261 may extend axially and circumferentially at an angle between 50° and 70°, or about 60° relative to the axially outermost groove 48. The angled sipes 241 may have a uniform radial depth between 1.0 mm and 3.0 mm, or 1.5 mm and 2.5 mm, or about 2.0 mm.

The fifth shoulder rib 28 may have axial sipes 281 that extend axially outward from the axially outermost groove 48 toward a second tread edge 23. Each of the angled sipes 241, 251, 261 may extend at the same angle relative to all of the circumferential grooves 42, 44, 46, 48 (FIG. 2). The shoulder sipes 221, 222, 223, 224, 281 may increase in width as they extend axially outward (FIG. 2). Such a tire 2 as described above may thus exhibit a pass-by-noise level below 65.0 dB(A), as well as provide acceptable rolling resistance, impact robustness, and ride and handling.

From the above description of an example of the present invention, those skilled in the art may perceive improvements, changes, and/or modifications. Such improvements, changes, and/or modifications within the skill of the art are intended to be covered by the appended claims.

What is claimed:

1. A tread for a tire having a midcircumferential plane, a first axial tread edge and a second axial tread edge, the tread comprising:
a first shoulder rib extending circumferentially about a perimeter of the tread;
a second shoulder rib extending circumferentially about the perimeter of the tread and
a first intermediate rib extending circumferentially about the perimeter of the tread, the first intermediate rib being defined by a first and a second circumferentially extending groove disposed to each axial side of the first intermediate rib, the first intermediate rib having a plurality of angled sipes extending both axially and circumferentially at an angle between 50° and 70° relative to the first circumferentially extending groove, the angled sipes each having a radial depth of between 1.0 mm and 3.0 mm.

2. The tread as set forth in claim 1 wherein the angled sipes have a uniform radial depth between 1.5 mm and 2.5 mm.

3. The tread as set forth in claim 1 wherein the angled sipes extend at an angle of about 60° relative to the first circumferentially extending groove.

4. The tread as set forth in claim 1 wherein the angled sipes have a uniform radial depth of about 2.0 mm.

5. The tread as set forth in claim 1 further including a second intermediate rib extending circumferentially about the perimeter of the tread, the second intermediate rib being defined by the first circumferentially extending groove and a third circumferentially extending groove disposed to each axial side of the second intermediate rib, the second intermediate rib having a plurality of angled sipes extending both axially and circumferentially at an angle between 50° and 70° relative to the third circumferentially extending groove, the angled sipes each having a radial depth of between 1.0 mm and 3.0 mm.

6. The tread as set forth in claim 5 further including a third intermediate rib extending circumferentially about the perimeter of the tread, the third intermediate rib being defined by the third circumferentially extending groove and a fourth circumferentially extending groove disposed to each axial side of the third intermediate rib, the third intermediate rib having a plurality of angled sipes extending both axially and circumferentially at an angle between 50° and 70° relative to the fourth circumferentially extending groove, the angled sipes each having a radial depth of between 1.0 mm and 3.0 mm.

7. The tread as set forth in claim 6 wherein the second intermediate rib is axially disposed between the first intermediate rib and the third intermediate rib.

8. The tread as set forth in claim 6 wherein the angled sipes of the first intermediate rib extend to a blind end at an axial location about midway across the first intermediate rib.

9. The tread as set forth in claim 6 wherein the angled sipes of the second intermediate rib extend to a blind end at an axial location about midway across the second intermediate rib.

10. The tread as set forth in claim 6 wherein the angled sipes of the third intermediate rib extend to a blind end at an axial location about midway across the third intermediate rib.

11. A method for reducing pass-by-noise of a tread, said method comprising the steps of:
extending a first shoulder rib circumferentially about a perimeter of the tread;
extending a second shoulder rib circumferentially about the perimeter of the tread;
extending a first intermediate rib circumferentially about the perimeter of the tread;
defining the first intermediate rib with a first and a second circumferentially extending groove disposed to each axial side of the first intermediate rib;
extending a first plurality of angled sipes axially and circumferentially across the first intermediate rib at an angle between 50° and 70° relative to the second circumferentially extending groove; and
extending the angled sipes to a radial depth of between 1.0 mm and 3.0 mm.

12. The method as set forth in claim 11 further including the step of extending the angled sipes to a uniform radial depth between 1.5 mm and 2.5 mm.

13. The method as set forth in claim 11 further including the step of extending the angled sipes at an angle of about 60° relative to the first circumferentially extending groove.

14. The method as set forth in claim 11 further including the step of extending the angled sipes have a uniform radial depth of about 2.0 mm.

15. The method as set forth in claim 11 further including the steps of extending a second intermediate rib circumferentially about the perimeter of the tread, defining the second intermediate rib by the first circumferentially extending groove and a third circumferentially extending groove disposed to each axial side of the second intermediate rib, extending a second plurality of angled sipes both axially and circumferentially across the second intermediate rib at an angle between 50° and 70° relative to the third circumferentially extending groove, and extending the second plurality of angled sipes each to a radial depth of between 1.0 mm and 3.0 mm.

16. The method as set forth in claim 15 further including the steps of extending a third intermediate rib circumferentially about the perimeter of the tread, defining the third intermediate rib the third circumferentially extending groove and a fourth circumferentially extending groove disposed to each axial side of the third intermediate rib, extending a third plurality of angled sipes both axially and circumferentially across the third intermediate rib at an angle between 50° and 70° relative to the fourth circumferentially extending groove, and extending the third plurality of angled sipes each to a radial depth of between 1.0 mm and 3.0 mm.

17. The method as set forth in claim 16 further including the step of extending the second intermediate rib axially between the first intermediate rib and the third intermediate rib.

18. The method as set forth in claim 16 further including the step of extending the first plurality of angled sipes to a blind end at an axial location about midway across the first intermediate rib.

19. The method as set forth in claim 16 further including the step of extending the second plurality of angled sipes to a blind end at an axial location about midway across the second intermediate rib.

20. The method as set forth in claim 16 further including the step of extending the third plurality of angled sipes to a blind end at an axial location about midway across the third intermediate rib.
